(19) United States
(12) Patent Application Publication
(10) Pub. No.: US 2009/0012901 A1
(43) Pub. Date: Jan. 8, 2009

(54) Multifactor authentication system for "cash back" at the point of sale

(75) Inventors: Moneet Singh, Austin, TX (US); Jeffrey Racho, Austin, TX (US)

Correspondence Address: Jeffrey Racho, Esq.;C/O MPOWER Mobile, Inc., Suite 2740, 401 Congress Avenue, Austin, TX, 78701, US

(73) Assignee: MPOWER Mobile, Inc.

(21) Appl. No.: 12/231,354

(22) Filed: Sep. 2, 2008

Related U.S. Application Data
(63) Continuation of application No. 11/706,667, filed on Feb. 14, 2007.

(51) Int. Cl. H04L 9/32

(52) U.S. Cl. 705/67

(57) ABSTRACT

Systems and methods are provided to allow for multifactor authentication of customers seeking to enter into “cash back” transactions at a merchant's point of sale. In an illustrative implementation, a user presents a prepaid payment card at a point of sale and requests a “cash back” transaction, the merchant thereupon verifying the customer has sufficient value to complete the transaction. The merchant then requests an authentication code from the user who then requests the authentication code from an outside party. The authentication code is delivered to the customer's mobile phone via a text message. The customer offers the authentication code to the merchant, who then allows the transaction to proceed if the authentication code is confirmed.

### CLAIM OF PRIORITY AND CROSS REFERENCE

This continuing patent application claims priority from and the benefit of U.S. patent application Ser. No. 11/706,667, filed Feb. 14, 2007, entitled “MULTIFACTOR AUTHENTICATION SYSTEM.”

### BACKGROUND

Automated Teller Machines (ATMs) generally use a four digit personal identification number (PIN) to authenticate a banking customer who wishes to withdraw money from the ATM using an ATM card. The four digit PIN, long the standard art for user authentication in the financial industry, may be replaced by a PIN of six digits in the near future in order to increase the security of user access to ATMs.

The ATM card used to access ATMs also generally doubles as a “PIN based debit card” which may be used for purchases or “cash back” transactions at certain point of sale (POS) systems. The term “payment card” will be used as term encompassing cards used as ATM cards, PIN based debit cards, prepaid cards or other card systems used to pay merchants at points of sale.

Although a six-digit PIN can offer a level of security greater than that offered by a four digit PIN, an overlay of an additional step to the current four-digit PIN standard may provide a higher level of security than simply increasing the PIN digit length.

The Short Message Service (“SMS”), often referred to as “text messaging,” allows digital mobile phones and other mobile communications devices to remit messages of up to one hundred and sixty characters in length over the mobile communications network to other mobile phone users. The use of SMS has grown significantly in recent years and all new mobile phones have the ability to send/receive SMS messages.

“Multifactor authentication” generally refers to a security authentication system in which more than one form of authentication is used to validate the identity of a user. For example, a webpage which asks a user to remit a single username/password combination may be considered a “single-factor” authentication system since it requests a single datum—a username/password combination—in order to validate a user's identity. The webpage may add additional procedures, such as checking the user's internet protocol (IP) address against a list of pre-approved IP addresses or sending a confirmation email to the user's verified email address, in order to add additional levels of user authentication, thereby implementing a “multifactor authentication” system for the webpage.

The Federal Financial Institutions Examination Council (FFIEC) has mandated that banks and financial institutions implement multifactor authentication systems for online access to accounts deemed to be “high risk.” It is expected that banks and financial institutions can seek to adopt multifactor authentication systems for all of their online account customers in the near future.

From the foregoing it is appreciated that there exists a need for systems and methods to ameliorate the shortcomings of existing practices used for authentication of users in payment processing and “cash back” transactions at the POS.

### SUMMARY

Systems and methods are provided to allow for financial institutions or payments processors to provide a multifactor authentication system for customers using card products for “cash back” transactions at a point of sale. In an illustrative implementation, the herein described systems and methods allow payments processors to implement a multifactor authentication system using a customer's mobile phone as the customer attempts to undertake “cash back” transactions at the POS.

In an illustrative implementation, an exemplary multifactor authentication system comprises a “Multifactor Authentication” engine and a computing environment which may be operated by a financial institution, payment processor or a third party. In the illustrative implementation, the multifactor authentication system comprises at least one instruction set providing at least one instruction to the “Multifactor Authentication” engine to process data representative of user authentication requests. Users of the multifactor authentication system implementing the herein described systems and methods can generally interact with it using text messages delivered via the Short Message Service (SMS) from the users' mobile phones, although other means of communication involving users' mobile phones, such as by an interactive voice response (IVR) system, multimedia messaging service (MMS) messages or applet software installed on the mobile phones are possible.

Other features of the herein described systems and methods are described further below.

### BRIEF DESCRIPTION OF THE DRAWING

Referring now to the drawing, in which like reference numbers refer to like elements throughout the various figures that comprise the drawing. Included in the drawing are the following figures:

FIG. 1 is a block diagram of an exemplary “Multifactor Authentication” environment depicting the components comprising the herein described systems and methods in accordance with the herein described systems and methods;

FIG. 2 illustrates a process undertaken by an illustrative implementation of the herein described systems and methods in which an IVR system or an SMS based system is used to authenticate a customer in a “cash back” transaction at a POS;

FIG. 3 illustrates a process undertaken by an illustrative implementation of the herein described systems and methods in which an SMS based system is used to authenticate a customer in a “cash back” transaction wherein the customer lacks a payment card at a POS;

FIG. 4 illustrates a flow chart diagram of an illustrative implementation of the herein described systems and methods.

### DETAILED DESCRIPTION

### Overview

Financial institutions and payments processors may use the method and system described herein to better protect their customers by adding multifactor authentication capabilities to POS payment devices. The herein described systems and methods can be embodied in an information technology system, such as an electronic system used for mobile commerce transactions using mobile or other electronic communications. A person skilled in the arts of computer programming, information technology system architectures, information technology system design and electronic communications technologies may adapt the herein described systems and methods to various information technology systems regardless of their scale.

In an implementation of the method and system described herein, a customer sets a secondary PIN for access to the account debited by use of his/her payment card. The secondary PIN will be used in the described system and may be pre-set at an online portal or by a phone system used by the financial institution holding the customer's funds. The customer can also register his/her mobile phone at the online banking portal or by a phone system specified by the bank. When a customer desiring to enter into a “cash back” transaction arrives at a POS, he/she will present the payment card to the merchant, who then enters the card information in his POS system and verifies with a payments processor that the funds are available in the customer's financial account.

After this verification, the merchant will request that the customer produce an “authorization code” to be provided from a payments processor so that the “cash back” transaction can be processed. The customer will then contact the payments processor through his/her mobile phone by calling an IVR system, by SMS messaging, by MMS messaging or by using applet software installed on the mobile phone. The payments processor will request the customer provide the secondary PIN either through the customer's mobile phone (again, through IVR, SMS, MMS or applet software means). After verifying the secondary PIN, the payments processor will remit an authorization code to the customer's mobile phone (again, through IVR, SMS, MMS or applet software means). The customer will then provide the authorization code to the merchant, who shall enter it into the POS system. The payments processor will receive the code provided to the merchant and verify that this received authorization code matches the code the payments processor delivered to the customer. If the codes match, the merchant is authorized to proceed with the “cash back” transaction.

In another implementation of the method and system described herein, the customer can enter into a “cardless cash back” transaction. In this implementation, the customer will provide the last several digits (typically four) of the primary account number (PAN) of his/her payment card account. Generally the PAN is a sixteen digit number embossed on the front of the customer's payment card. The customer will provide the PAN and other required information, such as the customer's name and the payment card's expiration date, to the merchant, who then enters the card information in his POS system and verifies with a payments processor that the funds are available in the customer's financial account. After this verification, the merchant will request that the customer produce an “authorization code” to be provided from a payments processor so that the “cash back” transaction can be processed. The customer will then contact the payments processor through the customer's mobile phone (again, through IVR, SMS, MMS or applet software means). The payments processor will request the customer provide the secondary PIN to the customer's mobile phone (again, through IVR, SMS, MMS or applet software means). After verifying the secondary PIN, the payments processor will remit an authorization code to the customer's mobile phone (again, through IVR, SMS, MMS or applet software means). The customer will then provide the authorization code to the merchant, who shall enter it into the POS system. The payments processor will receive the code provided to the merchant and verify that this received authorization code matches the code the payments processor delivered to the customer. If the codes match, the merchant is authorized to proceed with the “cash back” transaction.

A major strength of the invention is that the merchant may turn the POS into an ATM which uses strong multifactor authentication to provide “cash back” transactions which do not necessarily require a purchase by the customer.

### Exemplary “Multifactor Authentication” Environment

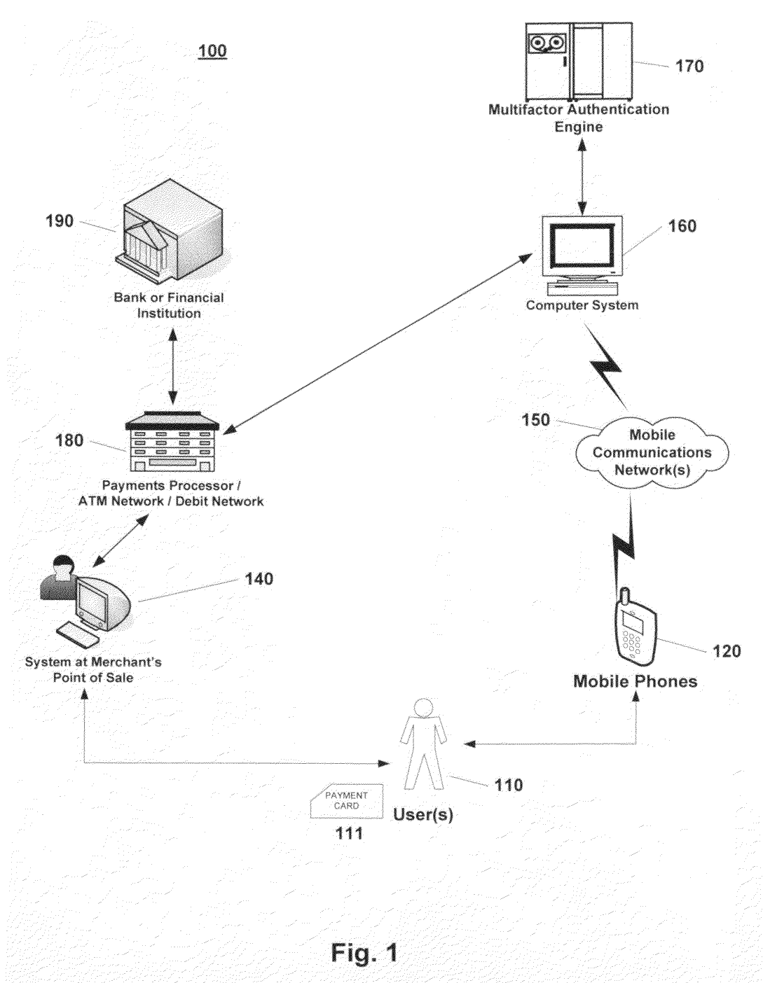

FIG. 1 illustrates the exemplary “Multifactor Authentication” Environment 100, which comprises customers 110 who may optionally have payment cards 111; mobile phones 120 owned/used by the customers; a merchant's point of sale system 140 which may have a barcode scanner, swipe system or other payment device acceptance hardware; the mobile telecommunications network 150; a computer environment 160; a Multifactor Authentication Engine 170; payments processors, ATM networks or debit networks 180; and banks or financial institutions 190. The exemplary “Multifactor Authentication” environment 100 may be implemented by a bank, a payments processor or a third party.

It is appreciated that, although the exemplary “Multifactor Authentication” Environment 100 is described to employ specific components having a particular configuration, such description is merely illustrative as the inventive concepts described herein can be performed by various components in various configurations.

Illustrative Processes when Using the Herein Described Systems and Methods

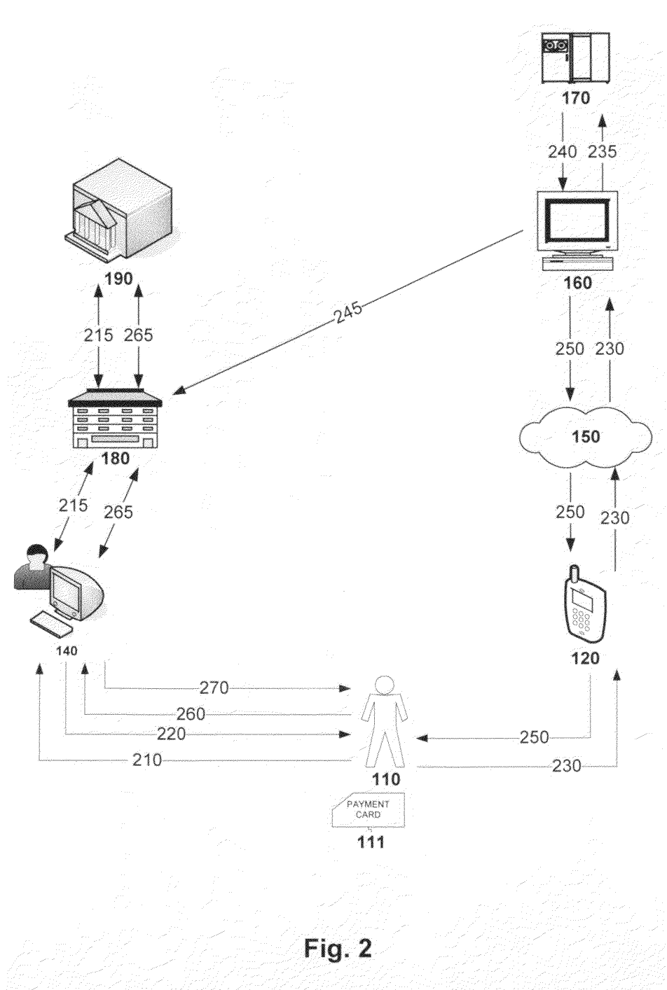

It is appreciated that the exemplary “Multifactor Authentication” Environment 100 of FIG. 1 can maintain various operations and features. FIGS. 2, 3 and 4 provide illustrative embodiments of exemplary processing by the exemplary “Multifactor Authentication” environment 100.

As is shown in FIG. 2, an illustrative process begins when a customer 110 with payment means (primarily a payment card) 111 and a mobile phone 120 approaches a merchant's POS system 130 intending to enter into a “cash back” transaction. The intended transaction will debit the customer's account at the bank 190 which issued the payment card through a payments processor 180. The customer will present the payment card to the merchant and ask to enter into the “cash back” transaction 210. The cash back transaction may optionally involve the purchase of goods or services or may be an ATM equivalent “cash only” transaction. The merchant will enter the request into the POS system and require the customer to provide the payment card. The POS system will communicate this information to the payments processor and bank in order to verify the customer's identity and verify that there are sufficient funds at the bank 215. The transaction will end if the payments processor or bank cannot verify that sufficient funds are in the customer's account in order to complete the transaction or if the card cannot be verified.

If the payments processor and bank can allow the transaction, then the merchant is notified to request the customer to provide an authorization code 220. After the merchant makes this request, the customer will use his/her mobile phone to initiate contact with the entity administering the system, such as by using his/her mobile phone 230 to contact a phone number or “short code” associated with the computer environment and the Multifactor Authentication Engine 235 (the computer environment and the Multifactor Authentication Engine may be operated by a bank, payment processor or third party). The customer shall request that the computer environment and the Multifactor Authentication Engine submit the authorization code to the customer. The request from the customer may also include a reference to the amount of funds subject to the “cash back” transaction.

Upon receiving the request from the customer, the computer environment and Multifactor Authentication Engine will request a secondary form of verification, such as a secondary PIN or the customer's PAN (the secondary PIN must be set up by the customer prior to using the system). This request may take the place of a request made through IVR, a text message sent via SMS to the customer's phone, an MMS message or a communication through the applet software on the phone. The computing system and Multifactor Authentication Engine will perform their own identity verification procedure 235 using the secondary PIN or customer's PAN submitted by customer. Once the customer has been verified by the computer environment and the Multifactor Authentication Engine 240, the computer environment and the Multifactor Authentication Engine shall deliver an authorization code to the customer's mobile phone and thereupon to the customer 250. The authorization code may be delivered in a text message sent via SMS or delivered to the customer over IVR. The computer environment and the Multifactor Authentication Engine shall also deliver the authorization code to the payments processor 245 which processes the payment requests from the merchant's POS.

The customer receives the authorization code on his/her mobile phone 250. The customer then delivers the authorization code to the merchant 260. The merchant enters the authorization code on the POS system which then provides it to the payments processor 265. If the payments processor determines that the authorization code supplied by the merchant 260 matches the authorization code supplied by the computer environment and the Multifactor Authentication Engine 245, then the payments processor will allow the “cash back” transaction to proceed and will notify bank to debit the customer's account 265 and will notify merchant to provide the proper funds to the customer 270.

The data communications comprising the communications between customer and the computing environment and Multifactor Authentication Engine (arrows 230, 250) may include other types of security measures in order to increase the security of the transaction and allow the computing environment and Multifactor Authentication Engine to verify the identity of the sender of the data communications which they receive. Such verification may include a verification of the phone number of the mobile phone from which the communications were sent. For such verification to be effective, the customer must register his/her mobile phone with the computer environment and Multifactor Authentication Engine.

The above described illustrative process is the preferred embodiment of the herein described systems and methods.

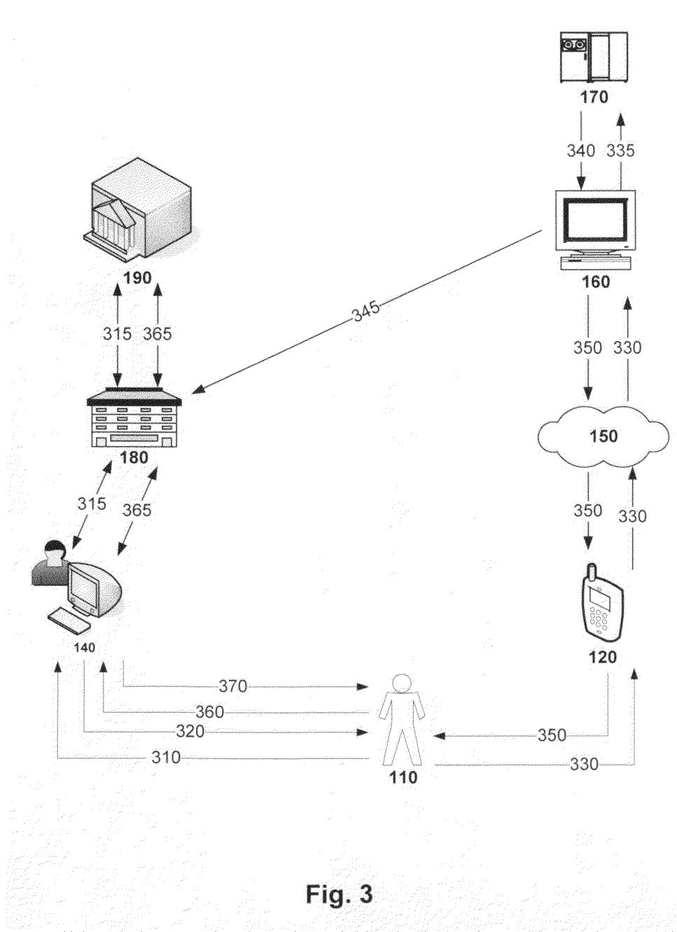

Another illustrative process of the system and methods is shown in FIG. 3. In this embodiment, a customer 100 lacking his/her payment card, but who knows several sequential digits of his/her card's PAN (such as the last four digits) and who has his/her mobile phone 120 approaches a merchant's POS system 130 intending to enter into a “cash back” transaction. The intended transaction will debit the customer's account at the bank 190 which issued the payment card through a payments processor 180. The customer will ask the merchant to enter into the “cash back” transaction 310 which may optionally involve the purchase of goods or services or may be an ATM equivalent “cash only” transaction. The merchant will enter the request into the POS system and require the customer to provide the string of several sequential digits of his/her card's PAN (such as the last four digits). The POS system will communicate this information to the payments processor and bank in order to verify the customer's identity and verify that there are sufficient funds at the bank 315. The transaction will end if the payments processor or bank cannot verify that sufficient funds are in the customer's account in order to complete the transaction or if the card cannot be verified.

If the payments processor and bank can allow the transaction, then the merchant is notified to request the customer to provide an authorization code 320. After the merchant makes this request, the customer will then use his/her mobile phone 330 to initiate contact with the entity administering the system, such as by using his/her mobile phone to contact a phone number or “short code” associated with the computer environment and the Multifactor Authentication Engine 235 (the computer environment and the Multifactor Authentication Engine may be operated by a bank, payment processor or third party). The customer shall request that the computer environment and the Multifactor Authentication Engine submit the authorization code to the customer. The request from the customer may also include a reference to the amount of funds subject to the “cash back” transaction and may also include an identifier datum which identifies the merchant's location.

Upon receiving the request from the customer, the computer environment and Multifactor Authentication Engine will request a secondary form of verification, such as a secondary PIN or the customer's PAN (which may be delivered via text messages or through IVR; in either case, the secondary PIN must be set up by the customer prior to using the system). This request may take the place of a request made by IVR, by SMS or MMS messages or by an applet running on the mobile phone. The computing system and Multifactor Authentication Engine will perform their own identity verification procedure 335 using the secondary PIN or customer's PAN submitted by customer. Once the customer has been verified by the computer environment and the Multifactor Authentication Engine 340, the computer environment and the Multifactor Authentication Engine shall deliver an authorization code to the customer's mobile phone and thereupon to the customer 350. The authorization code may be delivered by IVR, by SMS or MMS messages or by an applet running on the mobile phone. The computer environment and the Multifactor Authentication Engine shall also deliver the authorization code to the payments processor 345 which processes the payment requests from the merchant's POS.

The customer receives the authorization code on his/her mobile phone 350. The customer then delivers the authorization code to the merchant 360. The merchant enters the authorization code on the POS system which then provides it to the payments processor 365. If the payments processor determines that the authorization code supplied by the merchant 360 matches the authorization code supplied by the computer environment and the Multifactor Authentication Engine 345, then the payments processor will allow the “cash back” transaction to proceed and will notify bank to debit the customer's account 365 and will notify merchant to provide the proper funds to the customer 370.

The data communications sent by the customer's mobile phone comprising the communications between customer and the computing environment and Multifactor Authentication Engine (arrows 330, 350) may include other types of security measures in order to increase the security of the transaction and allow the computing environment and Multifactor Authentication Engine to verify the identity of the sender of the data communications which they receive. Such verification may include a verification of the phone number of the mobile phone from which the communications were sent. For such verification to be effective, the customer must register his/her mobile phone with the computer environment and Multifactor Authentication Engine.

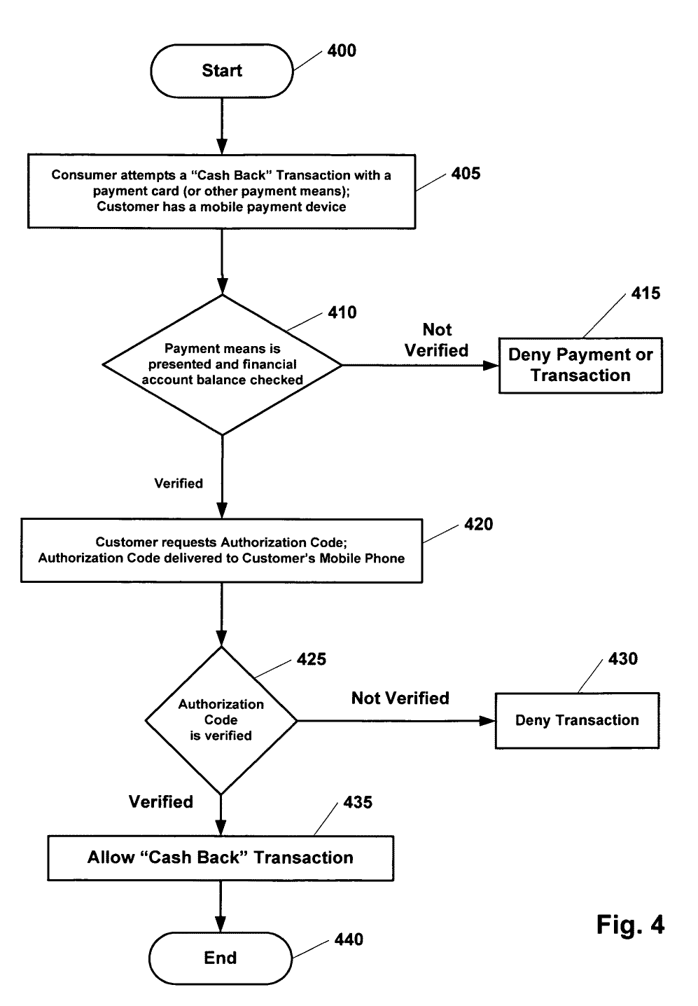

FIG. 4 presents an illustrative process of the herein described systems and methods in the form of a flow chart. At the start 400 of the process, a customer with a mobile phone makes a “cash back” transaction request at device POS 405. This transaction request or payment attempt necessitates that the customer present a means of payment, namely, payment card with an optional primary PIN, or a payments device such as a NFC/RFID device or barcode-equipped mobile phone, which must be authenticated. The payment means is then authenticated and the funds balance of the financial account associated with the customer's payment card is checked 410; if the verification of the payment means fails or if there are insufficient funds in the account, the transaction is denied 415, while if there are sufficient funds in the account and the verification of the payment means succeeds, the process proceeds to the next step.

After the payment means is authenticated and the account balance is verified, the customer initiates contact with the computing environment and Multifactor Authentication Engine by means of customer's mobile phone and requests an authorization code 420. As the customer must be in control of the mobile phone to which the second for of verification is delivered, the possession of the phone itself is a form of additional authentication. The customer receives the authorization code (after the customer's mobile phone is verified) and thereupon delivers the authorization code to the merchant 420. The authorization code is then verified; if the verification fails, the transaction or payment is denied 430, while if the verification succeeds, the transaction or payment is allowed 435, after which the process ends 440.

It is understood that the herein described systems and methods are susceptible to various modifications and alternative constructions. There is no intention to limit the herein described systems and methods to the specific constructions described herein. On the contrary, the herein described systems and methods is intended to cover all modifications, alternative constructions and equivalents falling within the scope and spirit of the herein described systems and methods.

It should also be noted that the herein described systems and methods may be implemented in a variety of computer environments (including both non-wireless and wireless computer environments), partial computing environments and real world environments. The various techniques described herein may be implemented in hardware or software, or a combination of both. Preferably, the techniques are implemented in computing environments maintaining programmable computers that include a processor, a storage medium readable by the processor (including volatile and non-volatile memory and/or storage elements), at least one input device, and at least one output device. Computing hardware logic cooperating with various instruction sets are applied to data to perform the functions described above and to generate output information. The output information is applied to one or more output devices. Programs used by the exemplary computing hardware may be preferably implemented in various programming languages, including high level procedural or object oriented programming language to communicate with a computer system. Illustratively the herein described systems and methods may be implemented in assembly or machine language, if desired. In any case, the language may be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The system may also be considered to be implemented as a computer-readable storage medium, configured with a computer program, where the storage medium so configured causes a computer to operate in a specific and predefined manner.

Although an exemplary implementation of the herein described systems and methods has been described in detail above, those skilled in the art can readily appreciate that many additional modifications are possible in the exemplary embodiments without materially departing from the novel teachings and advantages of the herein described systems and methods. Accordingly, these and all such modifications are intended to be included within the scope of this herein described systems and methods. The herein described systems and methods may be better defined by the following exemplary claims.

What is claimed is:

1. A method for authenticating the identity of a user attempting a financial transaction comprising:
receiving a submitted first data set from a user attempting a financial transaction;
authenticating the submitted first data set against a known first data set, wherein the known first data set contains information associated with the user, rejecting the financial transaction should the authentication of the submitted first data set fail;
submitting a request for a second data set to the user;
receiving a submitted second data set from the user;
authenticating the submitted second data set against a known second data set, wherein the known second data set contains information associated with the user, rejecting the financial transaction should the authentication of the submitted second data set fail; and
allowing the financial transaction to proceed should the submitted first data set and the submitted second data be properly authenticated.

2. A method for authenticating the identity of a user attempting a financial transaction comprising:
a first party receiving a payment means from a user attempting a financial transaction;
a second party authenticating the payment means against a known first data set, wherein the known first data set contains information associated with the payment means, rejecting the financial transaction should the authentication of the payment means fail, optionally further verifying the balance in a financial account associated with the payment means, rejecting the financial transaction should the financial account lack sufficient funds to complete the transaction;
a first party submitting a request for an authentication code to the user;
the user receiving the authentication code from a third party;
the first party receiving the authentication code from the user and delivering the authentication code to the second party;
the second party authenticating the authentication code set against a known second data set supplied by the third party, wherein the known second data set contains information associated with the authentication code, the second party rejecting the financial transaction should the authentication of the authentication code fail; and
the first party proceeding with the financial transaction should the payment means, balance and authentication code be properly verified or authenticated.

3. The method as recited in claim 2 in which the financial transaction is a “cash back” transaction at a point of sale system.

4. The method as recited in claim 2 in which the payment means is a credit card, a debit card, a barcode, a magnetic stripe, a near-field communications device, a radio frequency identification device, or a numeric code identifying a financial account.

5. The method as recited in claim 2 in which the authentication code is delivered to the user by an interactive voice response system, by a text message delivered by the short message service, by a multimedia message delivered by the multimedia message service or through use of the user's mobile phone.

6. The method as recited in claim 2 in which the request for the authentication code is submitted by the user using a text message delivered by the short message service, by a multimedia message delivered by the multimedia message service or through use of the user's mobile phone.

7. The method as recited in claim 2 in which the request for the authentication code includes one or more selected from the group: a personal identification number, data identifying the user's mobile phone, a numeric code identifying a financial account, and a user name identifying the user.

8. The method of claim 2 in which the first party is a merchant.

9. The method of claim 2 in which the financial account is maintained by a financial institution, bank or an entity that stores value owned by the user.

10. The method of claim 2 in which a payments processor acts as one or more of the following: the second party and the third party.

11. A computer system performing a method for authenticating the identity of a user attempting a financial transaction comprising the steps of:
a first party receiving a payment means from a user attempting a financial transaction;
a second party authenticating the payment means against a known first data set, wherein the known first data set contains information associated with the payment means, rejecting the financial transaction should the authentication of the payment means fail, optionally further verifying the balance in a financial account associated with the payment means, rejecting the financial transaction should the financial account lack sufficient funds to complete the transaction;
a first party submitting a request for an authentication code to the user;
the user receiving the authentication code from a third party;
the first party receiving the authentication code from the user and delivering the authentication code to the second party;
the second party authenticating the authentication code set against a known second data set supplied by the third party, wherein the known second data set contains information associated with the authentication code, the second party rejecting the financial transaction should the authentication of the authentication code fail; and
the first party proceeding with the financial transaction should the payment means, balance and authentication code be properly verified or authenticated.

12. The computer system as recited in claim 11 in which the financial transaction is a “cash back” transaction at a point of sale system.

13. The computer system as recited in claim 11 in which the payment means is a credit card, a debit card, a barcode, a magnetic stripe, a near-field communications device, a radio frequency identification device, or a numeric code identifying a financial account.

14. The computer system as recited in claim 11 in which the authentication code is delivered to the user by an interactive voice response system, by a text message delivered by the short message service, by a multimedia message delivered by the multimedia message service or through use of the user's mobile phone.

15. The computer system as recited in claim 11 in which the request for the authentication code is submitted by the user using a text message delivered by the short message service, by a multimedia message delivered by the multimedia message service or through use of the user's mobile phone.

16. The computer system as recited in claim 11 in which the request for the authentication code includes one or more selected from the group: a personal identification number, data identifying the user's mobile phone, a numeric code identifying a financial account, and a user name identifying the user.

17. The computer system of claim 11 in which the computer system is operated by a payments processor, a financial institution, a bank or an entity that stores value owned by the user.

18. The method of claim 11 in which the first party is a merchant.

19. The method of claim 11 in which the financial account is maintained by a financial institution, bank or an entity that stores value owned by the user.

20. The method of claim 11 in which a payments processor acts as one or more of the following: the second party and the third party.
